(19) United States
(12) Patent Application Publication
(10) Pub. No.: US 2006/0013933 A1
(43) Pub. Date: Jan. 19, 2006

(54) Method for conducting a cooking process using a cooking process sensor

(75) Inventors: Michael Fink, Wessling (DE); Gerd Funk, Landsberg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Rational AG, Landsberg/Lech (DE)

(21) Appl. No.: 10/507,391

(22) PCT Filed: Mar. 13, 2003
(86) PCT No.: PCT/EP03/02604

§ 371 Date: Jul. 7, 2005

(30) Foreign Application Priority Data
Mar. 15, 2002 (DE) 102 11 643.1

(51) Int. Cl. A23C 3/00

(52) U.S. Cl. 426/523

(57) ABSTRACT

In a method and system for conducting a cooking process in a cooking chamber of a cooking appliance using a cooking process probe which is to be inserted at least partly into an item being cooked in the cooking chamber for detecting at least one variable of the item being cooked, at least at one predetermined point in time, non-insertion of the cooking process probe into the item being cooked is automatically monitored. If non-insertion is detected, at least one of a first warning signal is emitted, a changeover is made to an emergency program, and a cooking program is avoided.

### BACKGROUND

The disclosure relates to a method for conducting a cooking process in a cooking chamber of a cooking appliance using a cooking process probe which is to be inserted at least partly into an item being cooked in the cooking chamber for detecting at least one variable of the item being cooked and it relates to a cooking appliance in particular for carrying out said method.

An increasing number of cooking process probes are being used for conducting a cooking process. A cooking process probe is known for example from DE 299 23 215.8. To allow the possibilities of conducting a cooking process that are mentioned there to be fully exploited, it is a pre-requisite that the cooking process probe is actually inserted in the item being cooked. This is so because, if the cooking process probe is outside the item being cooked, the cooking result may be made considerably worse, since the cooking process probe does not pick up any actual information on the item being cooked. The problems of detecting non-insertion are already discussed in DE 100 61 821.9-34, which is not a prepublished publication. In that case, temperature profiles detected by the sensors of the cooking process probe are evaluated, which does lead to satisfactory results but requires complicated software.

Further methods for detecting improper use of a cooking process probe are known from the prior art. For instance, a control device for cooking, roasting or baking processes with a food thermometer is known from DE 31 04 926 C2. This food thermometer comprises not only a sensor part having a temperature sensor but also an indicating device, by means of which the resistance of an item being cooked is measured and compared with a predefined reference value. If in this case the difference between the measured resistance value and the reference value exceeds a predefined threshold value, the conclusion is drawn that the cooking process probe is not in the item being cooked, and the cooking process is aborted. However, a disadvantage of the method used in this device is that false indications may occur. For instance, soiling of the indicating device may have the effect that the difference between the measured resistance value and the reference value lies below the predefined threshold value although the temperature sensor is not inside an item being cooked. This can lead to an undesired cooking result.

Furthermore, there are known cooking appliances in which mis-insertion of a cooking process probe is detected by a temperature measured by means of the cooking process probe being compared with a temperature prevailing in a cooking chamber. If the difference between these two measured temperatures lies below a predefined value, it is assumed that the cooking process probe has not been inserted correctly into the item being cooked. However, a disadvantage of the method used in these cooking appliances is that, in the case of a delta measurement, i.e. correction of the cooking chamber temperature on the basis of the temperature recorded by means of the cooking process probe, mis-insertion of the cooking process probe is possibly not detected.

In the not prepublished document WO 02/47 522 A2 of the applicant according to which temperature patterns of a surface temperature of an item being cooked, a core temperature of the item being cooked and/or a temperature of the cooking chamber are determined by means of a cooking process probe, to detect a non-insertion of the cooking process probe via the determined temperature pattern. Because of the necessity of the determination of temperature patterns a time offset in the detection of a non-insertion can occur which can influence the result of the cooking process negatively.

Also the not prepublished EP 1 271 061 A2 is based on the perception that by using temperature related information of a cooking process probe a non-insertion of the cooking process probe can be detected, which is associated with the same disadvantages known from the method of the WO 02/47 522 A2.

Finally, on the market there are also appliances for treating items being cooked which use a cooking process probe with its socket for connecting the cable to the cooking appliance arranged outside the cooking appliance. If the cooking process probe is not being used, the connector is closed by a cover. A cooking process with a cooking process probe line can only be started when the cooking process probe is connected to the cooking appliance via the connection. However, a disadvantage of these cooking appliances is that, in spite of the connection of the cooking process probe to a cooking appliance, a user can start the cooking process even if the cooking process probe has not been inserted into an item being cooked.

### SUMMARY

It is an object to develop the method of the generic type further in such a way that the disadvantages of the prior art are overcome. It is also intended to provide a cooking appliance which is improved in comparison with the prior art for carrying out such a method.

The object relating to the method is achieved according to the invention by providing at at least one predetermined point in time a monitoring to detect non-insertion of the cooking process probe, at least one of
a parameter is detected for monitoring whether the cooking process probe is in a standby position in a retaining device provided by the cooking appliance or in a measuring position in a positioning device provided by an accessory part for receiving the item being cooked,
a parameter is detected for monitoring whether the cooking process probe is removed from the retaining device or the positioning device,
a parameter is detected for monitoring whether the cooking process probe is moved and/or where the cooking process probe is positioned inside the cooking appliance, and
a parameter is detected for monitoring whether the cooking process probe is being grasped; and

if non-insertion is detected, at least one of a first warning signal is emitted, a changeover is made to an emergency program and a cooking program is aborted.

### BRIEF DESCRIPTION OF THE DRAWINGS

FIG. 1 shows a cooking appliance;

FIG. 2 shows a first embodiment of a retaining device for a cooking process probe as part of the cooking appliance of FIG. 1;

FIG. 3 shows a second embodiment of a retaining device;

FIG. 4 shows a third embodiment of a retaining device;

FIG. 5 shows a fourth embodiment of a retaining device;

FIG. 6 shows a fifth embodiment of a retaining device; and

FIG. 7 shows a cooking process probe for the cooking appliance of FIG. 1.

### DESCRIPTION OF THE PREFERRED EMBODIMENTS

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

To detect non-insertion of the cooking process probe, a monitoring is carried out to determine whether the cooking process probe is connected to the cooking appliance.

A particularly advantageous alternative embodiment of the method is characterized in that, the predetermined point in time is determined by the beginning of a cooking process, the end of a cooking process and/or an actuation, in particular opening or closing, of a cooking chamber door.

In the method, it may be provided in particular that, the detection is carried out over time and/or by forming time derivatives.

A further advantageous embodiment of the method provides that, to detect non-insertion of the cooking process probe, at least-one variable of the item being cooked is detected by means of the cooking process probe, a variation over time of the variable of the item being cooked and/or at least one derivative of the variation over time of the variable of the item being cooked is or are determined with respect to time, the determined variable of the item being cooked, and the determined variation over time and/or the determined derivative preferably being compared with at least one setpoint value.

Finally, it may be provided in the method that, dependent on the cooking process, a second warning signal is emitted if the cooking process probe is not placed in the retaining device, in order to call on an operator to place the cooking process probe in the retaining device, and/or a third warning signal is emitted if the cooking process probe is not placed in the positioning device, in order to call on an operator to place the cooking process probe in the positioning device.

The preferred embodiment also relates to a cooking appliance, in particular for carrying out a method with a cooking chamber, a cooking process probe which is to be inserted at least partly into an item being cooked in the cooking chamber for detecting at least one variable of the item being cooked. A non-insertion of the cooking process probe into the item being cooked is detectable by the use of
a sensor for monitoring whether the cooking process probe is in a standby position in a retaining device provided by the cooking appliance, or in a measuring position in a positioning device provided by an accessory part for receiving the item being cooked, and/or
a sensor for monitoring whether the cooking process probe has been removed form the retaining device or from the positioning device, and/or
a sensor for monitoring whether the cooking process probe is positioned inside the cooking appliance or whether the cooking process probe has been moved, and/or
a sensor for monitoring whether the cooking process probe has been grasped, and

If non-insertion is detected, at least a first warning signal can be emitted, a changeover can be made to an emergency program and/or the cooking program can be aborted for conducting a cooking process.

In this respect, it may be provided in particular that the sensor is comprised by the retaining device, the positioning device and/or the cooking process probe.

A cooking appliance may also be characterized by an input and/or output unit and/or an open-loop and/or closed-loop control unit in operative connection with the cooking process probe, a cooking chamber door, the sensor, the retaining device and/or the positioning device.

It is advantageously provided that the cooking process probe is captively connected to the cooking appliance.

Finally, a particularly advantageous embodiment of the cooking appliance is characterized by a cooling device, at least temporarily in operative connection with the cooking process probe and/or the retaining device, for cooling of at least one region of the cooking process probe.

The system and method is consequently based on the surprising finding that a method for detecting improper use of a cooking process probe, in particular non-insertion of the same into an item being cooked, can be carried out by being able to detect improper use at the beginning of a cooking process without a time delay, avoidance of detection by a user being at least made more difficult. In particular, use of the retaining device makes such detection possible for the cooking process probe in such a way that the application of a voltage or measurement of a conductivity value allows the determination of whether or not the cooking process probe is in the retainer, or has or has not been removed from it. In particular, comparison of the time of day of the removal and the start of the process at a time before or after it makes it possible for placement of the cooking process probe or omission of the same to be reliably assumed, and consequently improper use of the cooking process probe to be detected. In particular, the combination of various actions for handling the cooking process probe, not only detecting whether the cooking process probe has been removed from its holder, that is to say has been grasped, has been moved, has been positioned at any particular location and/or has been inserted into a cooking process probe holder of an accessory part, makes it possible for improper use of the cooking process probe to be detected essentially reliably.

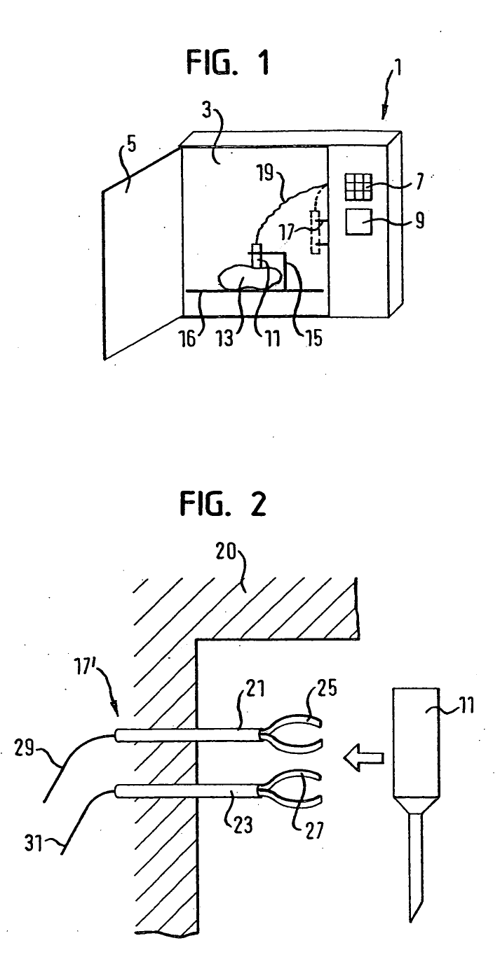

Represented in FIG. 1 is a cooking appliance 1 according to the invention with a cooking chamber 3, which can be closed by means of a cooking chamber door 5. Furthermore, the cooking appliance 1 comprises an input unit 7, by means of which a user can operate the cooking appliance 1. In particular, by means of the input unit 7, a user can program, start or end a cooking process or alter individual cooking parameters during a cooking process. By means of an output unit 9, information on the cooking appliance 1, an item being cooked and/or a cooking process can be given to a user. For this purpose, the output unit 9 comprises a display for indicating cooking parameters and/or an acoustic output unit for producing warning and/or information signals. The cooking appliance 1 also comprises a cooking process probe 11, which is captively connected by means of a cable 19 to the cooking appliance 1 in the cooking chamber 3. This connection prevents the cooking process probe 11 from being removed from the cooking appliance 1 during normal operation. To carry out a cooking process, the cooking process probe 11 is inserted into an item 13 being cooked, such as a roast joint, in particular to pick up at least a core temperature and, if appropriate, a surface temperature of the item 13 being cooked, these temperature values being used for controlling the subsequent cooking process. If needed, positioning of the cooking process probe 11 may take place by means of a positioning device 15, which can for example be fixedly connected to an accessory part 16 in the form of a metal sheet for carrying the item 13 being cooked. If the cooking process probe 11 is not used, in particular if no cooking process is being carried out, it can be deposited by a user in a standby position in a retaining device 17 fixedly connected to the cooking chamber 3. The position of the cooking process probe 11 in the retaining device 17 is presented by dashed lines in FIG. 1.

Although in FIG. 1 the retaining device 17 is represented inside the cooking chamber 3, and the cooking process probe is connected to the cooking appliance 1 by means of a cable 19, the retaining device may be arranged at any desired position of the cooking appliance and the cooking process probe may be wirelessly connected to the cooking appliance for the transmission of data on the item being cooked. The captivity of the cooking process probe is achieved by a warning sound being emitted from the output unit when the cooking process probe is removed from the cooking appliance.

The cooking appliance 1 also comprises a closed-loop control unit (not represented), by means of which it is possible, inter alia, to control a cooking process carried out in the cooking appliance 1. This control of the cooking process also comprises the method, by which improper use of the cooking process probe can be detected. In this respect, it is taken into account that, when carrying out a cooking process with the cooking process probe 11, a user should perform essentially predetermined actions on the cooking appliance 1, in particular on the cooking process probe 11. This is so because, before the beginning of a cooking process, a user should first open the cooking chamber door 5 and position the item 13 being cooked inside the cooking chamber 3. Subsequently, the user should remove the cooking process probe 11 from the retaining device 17 and insert it in the item 13 being cooked, in particular by means of the positioning device 15. Subsequently, the user should close the cooking chamber 3 by means of the cooking chamber door 5 and start the cooking process by means of the input 7, if appropriate after a time delay. During the subsequent cooking process, the cooking process probe 11 should remain essentially stationary in the item 13 being cooked and only once the cooking process has ended and the cooking chamber door 5 is opened should it be grasped by the user, and if appropriate removed from the positioning device 15 and inserted into the retaining device 17. If these desired actions for handling the cooking process probe do not take place during a cooking process, poor or even harmful cooking results may occur.

The method now offers the possibility of detecting when at least one desired action for handling the cooking process probe that is necessary for its proper use does not take place or it is mishandled, and of reacting to this, such as by emitting warning signals, changing over to an emergency program or aborting a cooking process.

A first desired action for handling the cooking process probe 11 is for example to remove the cooking process probe 11 from the retaining device 17, which of course presupposes that the cooking process probe 11 is in the retaining device 17 in the first place. If, however, the cooking process probe 11 is still in the retaining device 17 at the beginning of a cooking process, improper use of the cooking process probe 11 can always be directly concluded. Furthermore, improper use of the cooking process probe 11 can also be concluded for example if removal of the cooking process probe 11 from the retaining device 17 has taken place outside a specific time period before the beginning of the cooking process or the programming of the cooking process or the closing of the cooking chamber door 5. In such a case, it must be assumed that the cooking process probe 11 has not been inserted into the item 13 being cooked.

Represented in FIG. 2 is a first embodiment according to the invention of a retaining device 17′. The retaining device 17′ is fixedly attached to a cooking appliance wall 20 and comprises two fork-shaped holders 21, 23, which are designed as clips for receiving the cooking process probe 11. At least the surface regions of the holders 21, 23 which come into contact with the cooking process probe 11 (not shown) when it is inserted are comprised of a conductive material and consequently form contacts 25 and 27, respectively. The remaining regions of the holders 21 and 23 are preferably electrically insulated on the outside. The contacts 25 and 27 are connected to the closed-loop control unit via lines 29 and 31 in such a way that the contact 25 is at a potential of, for example, 12 volts, while the contact 27 is at a potential of, for example, 5 volts or ground. If the cooking process probe 11 is not in the retaining device 17, as represented, no current flow occurs between the contacts 25 and 27. Consequently, it can be concluded from the absence of a current flow between the contacts 25 and 27 that the cooking process probe 11 is not located inside the retaining device 17. If, on the other hand, the cooking process probe 11 is introduced into the holders 21 and 23 of the retaining device 17, a current flow between the contacts 25 and 27 occurs via the conductive surface of the cooking process probe 11.

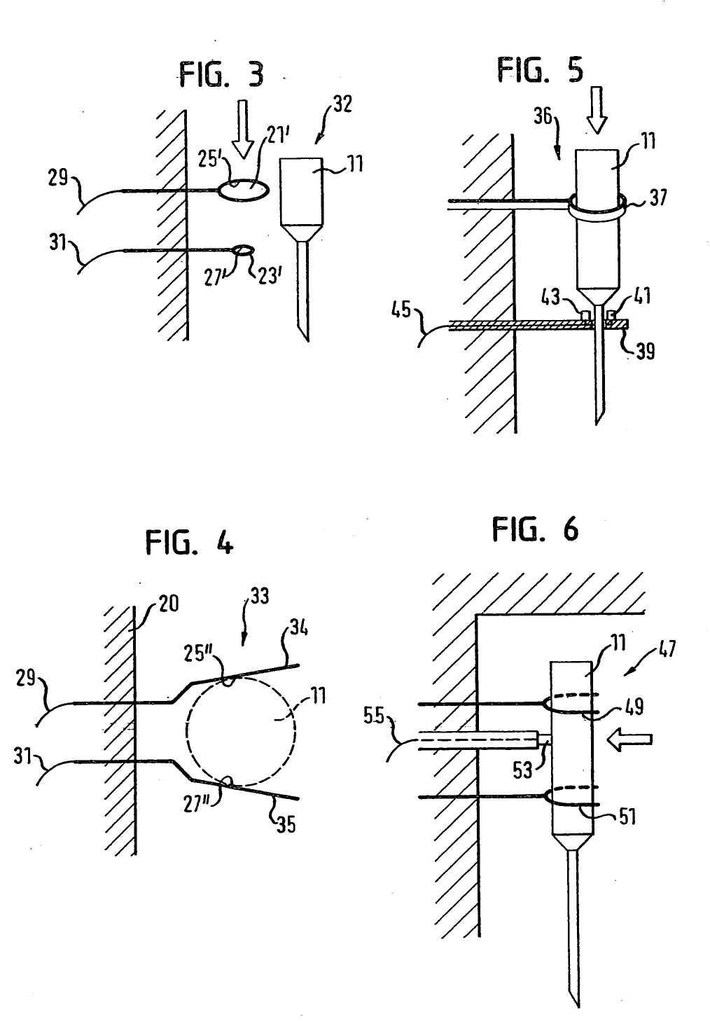

Represented in FIG. 3 is a second retaining device 32. By contrast with the first retaining device 17′, represented in FIG. 2, the second retaining device 32 comprises two annular holders 21′ and 23′, respectively. These in turn comprise contacts 25′ and 27′, respectively, which are connected to the closed-loop control unit via the lines 29 and 31. By contrast with the first retaining device 17′ represented in FIG. 2, the cooking process probe 11 cannot be clipped into the second retaining device 32, but must first be passed from above through the holder 21′ and with the tip through the holder 23′. The contacts 25′ and 27′ are at different potentials, so that presence of the cooking process probe 11 in the retaining device 32 can be concluded from a current flow between the contacts 25′ and 27′ via the surface of the cooking process probe 11.

Represented in FIG. 4 is a third retaining device 33. In this case, a fork-shaped holder, comprising two fork prongs 34 and 35, is fastened to the cooking appliance wall 20. The fork prongs 34, 35 have contacts 25″ and 27″, which are connected to the closed-loop control unit via the lines 29, 31. The contacts 25″ and 27″ are likewise at different potentials, so that no current flow can occur between the contacts 27″ and 25″ if the cooking process probe 11 is not located inside the holder. On the other hand, when the cooking process probe 11 is inserted into the retaining device 33, a current flow occurs between the contacts 25″ and 27″ via the surface of the cooking process probe 11.

Represented in FIG. 5 is a fourth retaining device 36. This retaining device 36 comprises annular holders 37 and 39. By contrast with the holders represented in FIGS. 2 to 4, the holders 37 and 39 have no contacts, but sensors 41 and 43, which are connected to the closed-loop control unit of the cooking appliance 1 via a line 45, are arranged on one holder 39. The sensors 41 and 43 comprise reed contacts, which are closed when the cooking process probe 11 is inserted with its tip through the holder 37 into the holder 39. The closing of the reed contacts has the effect for the method according to the invention of detecting that the cooking process probe 11 is located in the retaining device 36.

Represented in FIG. 6 is a fifth retaining device 47 according to the invention. This retaining device 47 comprises two fork-shaped holders 49, 51, into which the cooking process probe 11 can be clipped. Arranged between the holders 49 and 51 is a sensor 53. When the cooking process probe 11 is inserted into the holder 49 or 51, this closes the contact of the sensor 53, which is connected to the closed-loop control unit of the cooking appliance via a line 55. Closing of the contact means that the cooking process probe 11 is located in the holder 47.

The insertion of the cooking process probe 11 into the positioning device 15 represents a second desired action for handling the cooking process probe 11. This is so because, if when the positioning device 15 is being used the cooking process probe 11 is not inserted into it, improper use of the cooking process probe 11 can likewise be concluded.

Furthermore, improper use of the cooking process probe 11 can be concluded if the cooking process probe 11 is not moved in the time period in which the cooking chamber door 5 is open, the item 13 being cooked is introduced into the cooking chamber 3 and the cooking chamber door 5 is closed, since a corresponding movement represents a third desired handling action. It is then to be assumed that, although the cooking process probe 11 is inside the cooking chamber 3, it is outside the item 13 being cooked. Monitoring of the movement of the cooking process probe 11 may take place either by means of a movement sensor (not shown) arranged in the cooking process probe 11 or an electronic locating system for the cooking process probe 11 (not shown) arranged in the cooking appliance 1. Such a locating system also makes it possible in principle to establish whether the cooking process probe 11 is located inside or outside the cooking chamber 3.

A fourth desired handling action is that of grasping the cooking process probe 11, which likewise allows conclusions to be drawn concerning improper use of the cooking process probe 11. To detect this desired handling action, the cooking process probe 11 may comprise, for example, a conductivity sensor (not shown), which makes it possible to establish grasping of the cooking process probe 11 by a user. If such grasping does not occur, for example during the time period in which the cooking chamber door 5 is open, it can likewise be assumed that the cooking process probe 11 has not been inserted into the item 13 being cooked.

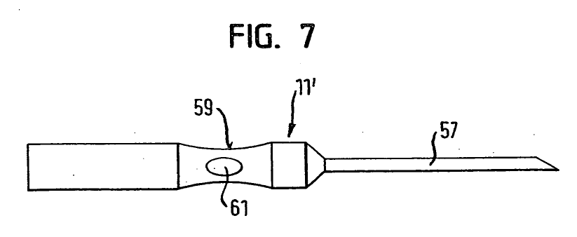

Also represented in FIG. 7 is a cooking process probe 11′ which comprises a number of temperature sensors (not represented) in its needle-shaped tip 57 and has a conductivity sensor 61 arranged on its recessed grip 59. If a user grasps the cooking process probe 11′ at the recessed grip 59, he touches the conductivity sensor 61, which then detects a change in conductivity. This leads to a detection of grasping of the cooking process probe 11′, which can be processed in the method.

The cooking process probe can advantageously be cooled by means of a cooling device (not represented), in order to make grasping of the recessed grip 59 more comfortable and/or to avoid an item being cooked from being damaged by insertion of a hot needle-shaped tip 57.

It may also be provided that the positioning device 15 has at least one of the design features represented in the exemplary embodiments of the retaining device.

Consequently, by monitoring various desired handling actions or mishandling actions, in particular of the cooking process probe 11, the method makes it possible to detect improper use, in particular non-insertion, of the same.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

1-11. (canceled)

12. A method for conducting a cooking process in a cooking chamber of a cooking appliance using a cooking process probe which is to be inserted at least partly into an item being cooked in the cooking chamber for detecting at least one variable of the item being cooked, comprising the steps of:
at least at one predetermined point in time, automatically monitoring to detect non-insertion of the cooking process probe in which at least one of
at least one of a conductivity value, a resistance value, an induction value, a capacitance, a pressure characteristic, and a characteristic of at least one of an electric, magnetic, and electromagnetic field is detected for monitoring whether the cooking process probe is in a standby position in a retaining device provided by the cooking appliance or in a measuring position in a positioning device provided by an accessory part for receiving the item being cooked,
at least one of a conductivity value, a resistance value, an induction value, a capacitance value, a potential difference value, a weight value, a moisture value, a radiation characteristic, a pressure characteristic, and a characteristic of at least one of an electric, magnetic, and electromagnetic field is detected for monitoring whether the cooking process probe is removed from the retaining device or the positioning device,
at least one of radiation characteristics and a characteristic of at least one of an electric, magnetic and electromagnetic field is detected for monitoring whether the cooking process probe is at least one of moved and positioned inside the cooking appliance, and
at least one of a conductivity value, a resistance value, an induction value, a capacitance value, a potential difference value, a moisture value, a radiation characteristic, a pressure characteristic and a characteristic of at least one of an electric magnetic and electromagnetic field is detected for monitoring whether the cooking process probe is being grasped; and
if non-insertion is detected, at least one of a first warning signal is emitted, a changeover is made to an emergency program, and a cooking program is aborted.

13. A method of claim 12 wherein to detect non-insertion of the cooking process probe, a monitoring is carried out to determine whether the cooking process probe is connected to the cooking appliance.

14. A method of claim 12 wherein the predetermined point in time is determined by at least one of a beginning of the cooking process, an end of the cooking process, and an actuation of a cooking chamber door.

15. A method of claim 12 wherein the detecting is carried out by at least one of over time and by forming time derivatives.

16. A method of claim 12 wherein to detect non-insertion of the cooking process probe, at least one of at least one variable of the item being cooked detected by means of the cooking process probe, a variation over time of the variable of the item being cooked, and at least one derivative of the variation over time of the variable of the item being cooked is determined with respect to time, at least one of the determined variable of the item being cooked, the determined variation over time, and the determined derivative being compared with at least one set point value.

17. A method of claim 12 wherein dependent on the cooking process, at least one of a second warning signal is emitted if the cooking process probe is not placed in the retaining device in order to call on an operator to place the cooking process probe in the retaining device, and a third warning signal is emitted if the cooking process probe is not placed in the positioning device in order to call on an operator to place the cooking process probe in the positioning device.

18. A cooking appliance, comprising:
a cooking chamber and a cooking process probe for insertion at least partly into an item being cooked in the cooking chamber and which detects at least one variable of the item being cooked;
a system which detects a non-insertion of the cooking process probe into the item being cooked, comprising at least one of
at least one of electrical contacts, a contact sensor, a pressure sensor, a light barrier, an ultrasonic sensor, a reed contact, a light sensor, and a conductivity sensor for monitoring whether the cooking process probe is in at least one of in a standby position, in a retaining device provided by the cooking appliance, and in a measuring position in a positioning device provided by an accessory part for receiving the item being cooked,
at least one of electrical contacts, a contact sensor, a pressure sensor, a light barrier, an ultrasonic sensor, a reed contact, a light sensor and a conductivity sensor for monitoring whether the cooking process probe has been removed from at least one of the retaining device and the positioning device,
at least one of a light barrier, an ultrasonic sensor, a locating system, a movement sensor and a light sensor for monitoring whether the cooking process probe is at least one of positioned inside the cooking appliance and whether the cooking process probe has been moved, and
at least one of electrical contacts, a contact sensor, a pressure sensor, a light barrier, an ultrasonic sensor, a light sensor, a conductivity sensor and a moisture sensor for monitoring whether the cooking process probe has been grasped; and
if non-insertion is detected, at least one of a first warning signal is emitted, a changeover is made to an emergency program, and the cooking program is aborted for conducting a cooking process.

19. A cooking appliance of claim 18 wherein at least one of the retaining device, the positioning device, and the cooking process probe senses whether the cooking process probe is inserted.

20. A cooking appliance of claim 18 wherein at least one of an input unit, an output unit, an open-loop control unit, and a closed-loop control unit are in operative connection with at least one of the cooking process probe, a cooking chamber door, the sensor, the retaining device, and the positioning device.

21. A cooking appliance of claim 18 wherein the cooking process probe is captively connected to the cooking appliance.

22. A cooking appliance of claim 18 wherein a cooling device is provided at least temporarily in operative connection with at least one of the cooking process probe and the retaining device for cooling of at least one region of the cooking process probe.

23. A method for conducting a cooking process in a cooking chamber of a cooking appliance using a cooking process probe which is to be inserted at least partly into an item being cooked in the cooking chamber for detecting at least one variable of the item being cooked, comprising the steps of:
at least at one predetermined point in time, automatically monitoring to detect non-insertion of the cooking process probe into the item being cooked; and
if non-insertion is detected, at least one of a first warning signal is emitted, a changeover is made to an emergency program, and a cooking program is aborted.

24. The method of claim 23 wherein it is determined whether or not the cooking process probe is in a standby position in a retaining device.

25. A method of claim 23 wherein it is detected whether the cooking process probe is in a measuring position in a positioning device which positions the measuring probe for insertion into the item being cooked.

26. A method of claim 23 wherein it is detected whether or not the cooking process probe is being grasped.

27. A cooking appliance, comprising:
a cooking chamber and a cooking process probe for insertion at least partly into an item being cooked in the cooking chamber and which detects at least one variable of the item being cooked; and
a system which detects at least at one predetermined point in time a non-insertion of the cooking process probe into the item being cooked.

28. A cooking appliance of claim 25 wherein a retainer device is provided for holding the cooking process probe in a standby position and said system which detects non-insertion determining whether the cooking process probe is in the standby position.

29. A cooking appliance according to claim 25 wherein a positioning device is provided for positioning the cooking process probe into the item being cooked and said system which detects non-insertion determining whether the cooking process probe is positioned in the positioning device.
